(19) United States
(12) Patent Application Publication
(10) Pub. No.: US 2026/0093044 A1
(43) Pub. Date: Apr. 2, 2026

(54) Multiple Constellation Terminal and Method Thereof

(71) Applicant: Gilat Satellite Networks Ltd., Petah Tikva (IL)

(72) Inventor: Ran Tamam, Ramat HaKovesh (IL)

(21) Appl. No.: 19/345,345

(22) Filed: Sep. 30, 2025

Related U.S. Application Data
(60) Provisional application No. 63/701,111, filed on Sep. 30, 2024.

(51) Int. Cl. G01S 19/25

(52) U.S. Cl. CPC G01S 19/258; G01S 19/256

(57) ABSTRACT

In a satellite communication system, a terminal may receive at least one information record corresponding to a service area, the record comprising at least a constellation identifier, a start position figure and a stop position figure. Responsive to determining it is at about the service area, the terminal may determine one or more satellites associated with a constellation of satellites corresponding to the constellation identifier, calculate one or more positions associated with the one or more satellites, and select from the one or more satellites, based on the start position figure and the stop position figure corresponding to the service area and on the calculated one or more positions, a servicing satellite.

### CROSS REFERENCE TO RELATED APPLICATIONS

The present application claims the benefit of and is a non-provisional of U.S. Application No. 63/701,111, filed Sep. 30, 2024, which is hereby incorporated by reference in its entirety.

### FIELD OF ART

### Technical Field

Aspects of the disclosure pertain to the field of satellite communication.

### Background

Connectivity to the Internet is considered a vital service. Considerable resources are being invested in providing Internet connectivity anytime anywhere, including at remote areas and on moving platforms (e.g., aircrafts, maritime vessels, etc.). Some methods for delivering Internet connectivity to remote areas and onboard moving platforms are based on using communication satellites.

Traditionally, communication satellites were almost exclusively geostationary satellites positioned on the geosynchronous arc (e.g., at about 36,000 kilometers above the Earth equator). Using geostationary satellites also allows use of relatively simple, and less expensive, terminal designs (e.g., based on non-tracking dish antennas). However, geostationary satellites also have two significant disadvantages: limited capacity, due to a limited number of “slots” on the geosynchronous arc, and relatively high round-trip latency, because even at the speed of light it takes nearly 250 millisecond for a signal to travel about 72,000 kilometers from the earth surface to a geostationary satellite and back. Following an increasing demand for capacity (e.g., more users, higher data rates) and a decreasing tolerance to latency, communication satellites in increasing numbers, belonging to several different constellations, are being positioned in Mean Earth Orbits (MEO) and in Low Earth Orbits (LEO).

From a point of view of a terminal, multiple satellites may be visible at any given time, some may be associated with a same constellation, others may be associated with different constellations, and some may be geostationary satellites. In addition, a terminal, especially a mobile one, may be associated with several services over different constellations (e.g., either at a same location or at different locations).

While operational, a terminal may be commanded (e.g., by a management entity) to use a specific satellite at any given time. Alternatively, a terminal may be provided (e.g., in advance) sufficient information to enable it to determine an appropriate satellite by itself. However, if the terminal is not operational and/or has not been operational for a period of time and/or may have been moving, picking an appropriate satellite may not be that simple.

According to one approach, picking an appropriate satellite may be based on link quality. Thus, a satellite associated with a higher elevation angle of a terminal antenna and/or with a shorter distance from the terminal may be considered optimal and may be preferred. Unfortunately, an optimal satellite might not be an appropriate satellite. For example, an optimal satellite might not be associated with the correct constellation (e.g., service). In another example, even if an optimal satellite is associated with a correct constellation (e.g.., service), it may not provide service at the terminal location (e.g., no covering beam).

According to another approach, picking an appropriate satellite may be based on providing a terminal sufficient information regarding relevant satellites to enable the terminal to select an appropriate satellite anywhere anytime. However, at least for networks of global coverage, the volume of information required may be quite significant (e.g., about 100MB, perhaps more). Moreover, as such networks have dynamic characteristics (e.g., satellites are brought into service or taken out of service, service beams are added, modified in any number of aspects, or removed, etc.), the information the terminal needs for selecting an appropriate satellite may change from time to time and may need to be repeatedly updated. Furthermore, in case the terminal is inactive for weeks or months, old information the terminal may have stored in non-volatile memory may be useless, in whole or in part.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some aspects of the disclosure in a simplified form as a prelude to the description below.

According to aspects of the disclosure, a method may comprise receiving or generating, at a management entity of a satellite communication system, at least one information record corresponding to a service area associated with the satellite communication system. The at least one information record may include an identifier associated with a satellite (e.g., a NORAD Identifier), a service start timestamp that may correspond to a time at which the satellite may start servicing the service area, and a service stop timestamp that may correspond to a time at which the satellite may stop servicing the service area. The method may further comprise calculating, at the management entity and based on the at least one information record and on ephemeris data corresponding to the satellite, a start position that may correspond to the service start timestamp, and a stop position that may correspond to the service stop timestamp. The method may further comprise transmitting, by the management entity and via at least one satellite, a service area information record corresponding to the service area. The service area information record may comprise at least a constellation identifier corresponding to the satellite, the start position, and the stop position.

The method may further comprise transmitting, by the management entity and via at least one satellite, at least one ephemeris data record (e.g., in three-line-element (3LE) format) corresponding to a satellite associated with the constellation, wherein the at least one ephemeris data record includes the constellation identifier associated with the constellation (e.g., in a title line of the ephemeris data record).

According to aspects of the disclosure, a method may comprise receiving, at a terminal of a satellite communication system and via at least one satellite, at least one service area information record corresponding to a service area, the service area information record may comprise at least a constellation identifier corresponding to a constellation of satellites, a start position figure and a stop position figure, wherein the start position figure and the stop position figure may correspond to the constellation of satellites. The method may further comprise receiving, at the terminal and via at least one satellite, at least one ephemeris data record comprising a constellation identifier corresponding to the constellation of satellites and ephemeris data corresponding to a satellite associated with the constellation of satellites. The method may further comprise storing any of the at least one service area information record and the ephemeris data record in a memory associated with the terminal.

The method may further comprise determining, at the terminal, that the terminal is at about the service area and, based on the stored at least one service area information record, a constellation identifier associated with the service area. The method may further comprise determining, at the terminal and based on stored ephemeris data records, one or more satellites associated with the constellation of satellites, wherein the constellation of satellites may correspond to the constellation identifier. The method may further comprise calculating, at the terminal, for at least one satellite of the one or more satellites (e.g., associated with the constellation of satellites) and based on the stored at least one ephemeris data record corresponding to the at least one satellite, a position associated with the at least one satellite, wherein the calculated position may correspond to a time of interest. The method may further comprise selecting, at the terminal, from the one or more satellites associated with the constellation of satellites, based on the start position and the stop position corresponding to the service area and on calculated positions associated with the one or more satellites, a servicing satellite. The selecting may comprise comparing the calculated position of the servicing satellite with the start position and the stop position associated with the service area and determining that the servicing satellite's calculated position may be between the start position and the stop position. The method may further comprise commanding, at the terminal, at about the time of interest, an antenna included in the terminal, to search for the selected service satellite at about the calculated position of the satellite.

According to aspects of the disclosure, a terminal may comprise an antenna configured to receive at least one transmission from at least one satellite and a modem coupled to the antenna and configured to control at least a pointing direction of the antenna. The modem may be further configured to perform the method(s) described above.

### BRIEF DESCRIPTION OF THE DRAWINGS

Having thus described the disclosure in general terms, reference will now be made to the accompanying drawings, which are not necessarily drawn to scale, and wherein:

FIG. 1 shows an example of a satellite communication system.

FIG. 2 shows an example method for generating a service area information record corresponding to a service area associated with a satellite communication system.

FIG. 3 shows an example flow chart in accordance with aspects of the disclosure.

FIG. 4 shows an example flow chart in accordance with aspects of the disclosure.

FIG. 5 shows an example flow chart in accordance with aspects of the disclosure.

FIG. 6 shows an example diagram of an information item in accordance with aspects of the disclosure.

FIG. 7 shows an example diagram of an information item in accordance with aspects of the disclosure.

### DETAILED DESCRIPTION

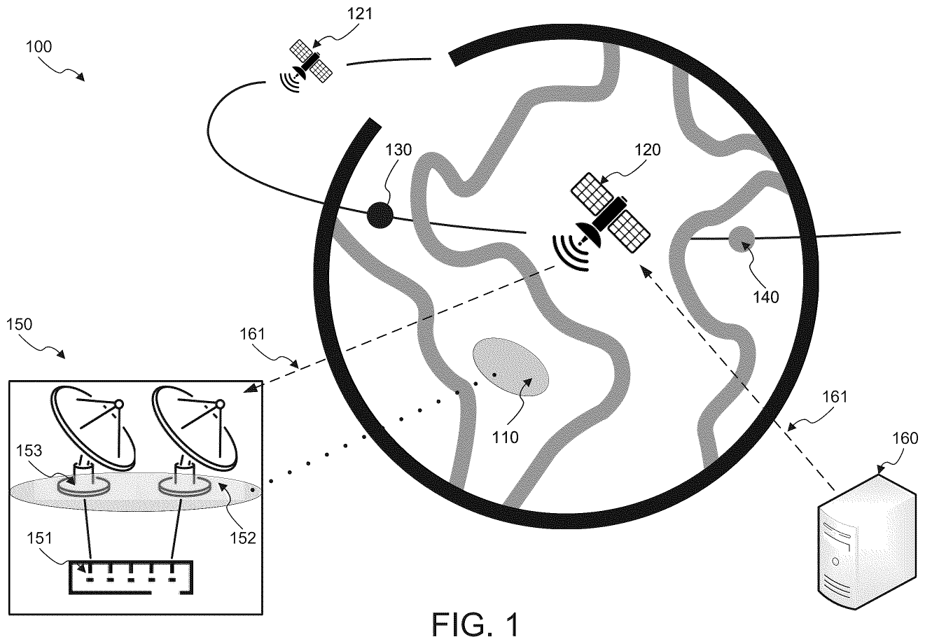

FIG. 1 shows an example of a satellite communication system. Specifically, FIG. 1 shows an example of a satellite communication system 100 comprising at least one constellation of satellites (120, 121) and a terminal 150. The terminal 150 may comprise an antenna 152 and a modem 151 coupled to the antenna 152. The terminal 150 may be stationary. The terminal 150 may be mobile, for example, the terminal 150 may be mounted on a mobile platform including, without limiting, any of a ground vehicle, a maritime vessel, or an aircraft.

An antenna 152 may be configured to receive (e.g., over electromagnetic waves) information from at least one satellite, and/or transmit (e.g., using electromagnetic waves) information to the at least one satellite. The antenna 152 may be configured for communicating (e.g., receiving and/or transmitting) with at least one geostationary satellite (e.g., a satellite orbiting the Earth at Clarke's Belt). The antenna 152 may be configured to be mounted on a mobile platform and/or configured for communicating with at least one non-geostationary satellite and/or with at least one non-geosynchronous (NGSO) satellite. For example, the antenna 152 may comprise a means for steering a reception beam associated with the antenna and/or a means for steering a transmission beam associated with the antenna, for at least the purpose of tracking satellite movements relative to the terminal 150. For example, the steering means may be electronical, mechanical, or a combination of electronical and mechanical. The antenna 152 may be configured to communicate in a single frequency band, for example, in any of the Ka band, the Ku band, or the C band. The antenna 152 may be configured to communicate in multiple frequency bands (e.g., the Ka band, the Ku band and the C band), yet perhaps only in one of the multiple frequency bands at any given time.

A terminal 150 may further comprise a second antenna 153 and the modem 151 may be coupled to the antenna 152 and to the second antenna 153, for example, to communicate with two satellites at about a same time (e.g., during service handover between satellites). The second antenna 153 may be similar to the antenna 152. The modem 151 may be configured to control at least a pointing direction of the antenna 152 and/or a pointing direction of the second antenna 153 (e.g., if the second antenna 153 exists). The antenna 152 may comprise an antenna control unit (ACU), and the modem 151 may be configured to control the antenna 152 by exchanging control messages (e.g., in accordance with an Internet Protocol (IP) based protocol over Ethernet LAN) with the ACU of the antenna 152. Similarly, the modem 151 may be configured to control the second antenna 153, if the second antenna 153 exists.

The at least one constellation of satellites (120, 121) may comprise one or more geostationary satellites. For example, three (3) geostationary satellites may be used for providing service almost anywhere on Earth (e.g., with the exception of polar regions). The at least one constellation of satellites may comprise a plurality of NGSO satellites, the plurality of NGSO satellites may be associated with a common orbit or with a set of orbits (e.g., of about a same altitude).

A communication system 100 may comprise more than one constellation of satellites, for example, a constellation of geostationary satellites and a constellation of NGSO satellites. In another example, the communication system 100 may comprise two constellations of NGSO satellites, either of similar altitudes (e.g., two mean earth orbit (MEO) constellations) or of substantially different altitudes (e.g., a MEO constellation and a low earth orbit (LEO) constellation). Each constellation of satellites (120, 121) may be configured to provide service (e.g., coverage) in one or more service areas (e.g., via one or more corresponding user beams), and a service area 110 may be covered (e.g., in whole or in part) by more than one constellation of satellites.

A communication system 100 may comprise an NGSO constellation of satellites (120, 121), and a service area 110 may be continuously covered (e.g., serviced) by handing over, from time to time, the coverage of the service area 110, for example, from a satellite 120 (e.g., of the NGSO constellation of satellites) covering the service area 110 to a next satellite 121 (e.g., of the NGSO constellation of satellites) that may be starting to cover the service area 110. The NGSO constellation of satellites (120, 121) may be configured to facilitate make-before-break (MBB) handovers, for example, in a terminal 150 comprising at least two antennas. In a terminal 150 comprising two antennas (152, 153) the modem 151 may be configured to use one antenna (e.g., 153) for establishing communication with a next satellite (121) while using the other antenna (e.g., 152) for communication with the current satellite (120), and to switch a transfer of information from the current satellite (120) to the next satellite (121) after, or in response to, communication with the next satellite being established.

A communication system 100 may further comprise a management entity 160. The management entity 160 may be configured to generate control information 161 and to transmit the control information 161 to the terminal 150, for example, via one or more satellites (e.g., 120) of the one or more constellations of satellites. For example, the management entity 160 may be configured to receive location information from the terminal 150 and, based on the location information (e.g., the service area the terminal may be at (110)), generate and transmit to the terminal 150 a handover plan (HOP). The HOP may include information regarding one or more service handover plans that may be scheduled for the service area 110 in a near future (e.g., within several hours to a day or two). Each service handover plan may include at least a start time and a stop time (e.g., in accordance with coordinated universal time (UTC)), and an identifier corresponding to the satellite that may cover the service area during the specified interval (e.g., from start time to stop time). The identifier corresponding to the satellite may comprise a satellite catalog number, for example, in accordance with the catalog of the North American Aerospace Defense Command (NORAD).

Control information 161 may include (e.g., in addition to HOPs) ephemeris data corresponding to one or more satellites of the one or more constellations of satellites. Ephemeris data corresponding to a satellite may be used for calculating a position of the satellite. The ephemeris data may be in a two-line element (TLE) format, wherein any of the first line and the second line include a catalog number (NORAD ID) for the satellite.

Control information 161 may further include a collection of service area information records, wherein each service area information record of the said collection of records may correspond to a service area (e.g., service area 110) associated with the communication system 100. For example, a service area information record may comprise multiple sets of coordinates describing the service area boundaries, and/or at least a frequency parameter and a symbol rate parameter associated with a carrier that may be transmitted from a covering satellite towards the service area.

A modem 151 of a terminal 150 may be configured to determine that it may have (e.g., in a memory of the modem 151) a valid HOP, for example, a HOP that includes an in-progress service handover plan (e.g., a service handover plan that corresponds to the service area the modem may be at (110), having a start time that may have already passed and a stop time that may yet to arrive). The modem 151, upon determining that it may have a valid HOP, may be configured to determine, at least the satellite designated to cover the service area 110 and to control an antenna of the terminal (e.g., 152 or 153). The modem 151 may determine at least the satellite designated to cover the service area 100, for example, based on an in-progress service handover plan included in the valid HOP. The modem 151 may control an antenna of the terminal (e.g., 152 or 153), for example, to find and track the satellite.

A modem 151 may be further configured to determine that it may not have a valid HOP. For example, the modem 151 may be turned on for a first time or after being inactive for some time, and any HOP it may have in memory might be outdated (e.g., invalid). It may be noted, that at least in some of these examples, ephemeris information that the modem 151 might have may be outdated as well, for example, there may be a substantial difference (e.g., several kilometers) between a calculated position of a satellite and the satellite actual position. In another example, a modem 151 may be turned on while the terminal 150 may be at a service area different from the service area associated with a HOP the modem 151 might have previously obtained. While it may be possible to generate and transmit to the terminal a HOP for each service area associated with the communication system 100, such brute-force approach might be impractical (e.g., due to an implied volume of control information 161 required). At least in the examples specified above, a modem 151 may not use a HOP to determine which satellite (e.g., of one or more satellites of one or more constellations of satellites) may be the satellite covering the service area (e.g., 110) where the terminal 150 may be located.

Communication system 100 may comprise one or more constellations of NGSO satellites. Consequently, several satellites of the one or more constellations of satellites may be visible from the service area 110, for example, at a time a terminal 150 may be at about the service area 110 and perhaps attempting to establish communication with and/or via a satellite. However, perhaps only one of the several satellites (e.g., 120, 121) may be the satellite providing the required service over the service area 110. In the absence of a valid HOP, the modem may be unable to conclusively determine a satellite from several visible satellites, and therefore may select a wrong satellite, and selecting a wrong satellite may result in a service outage and/or longer service outages.

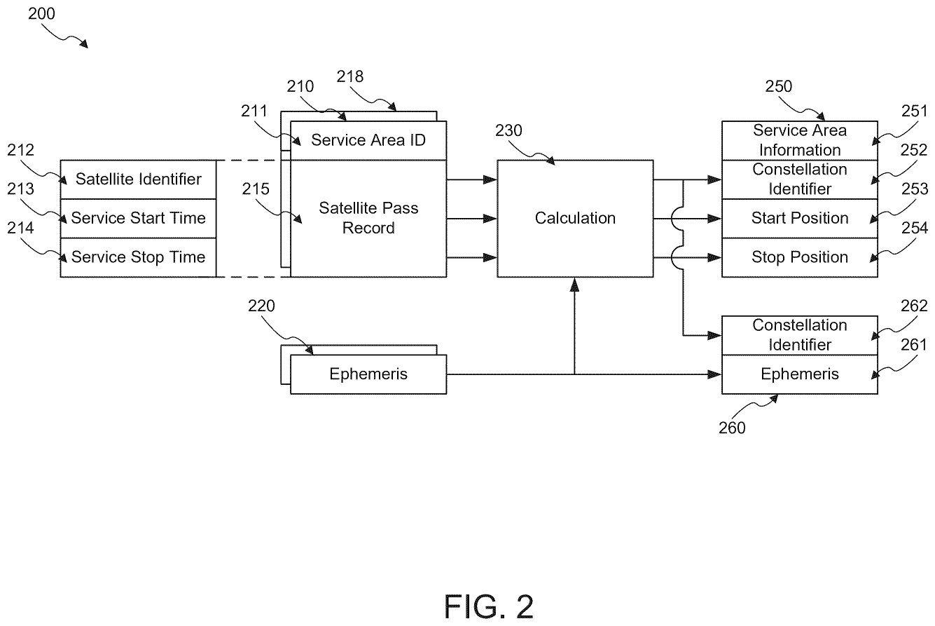

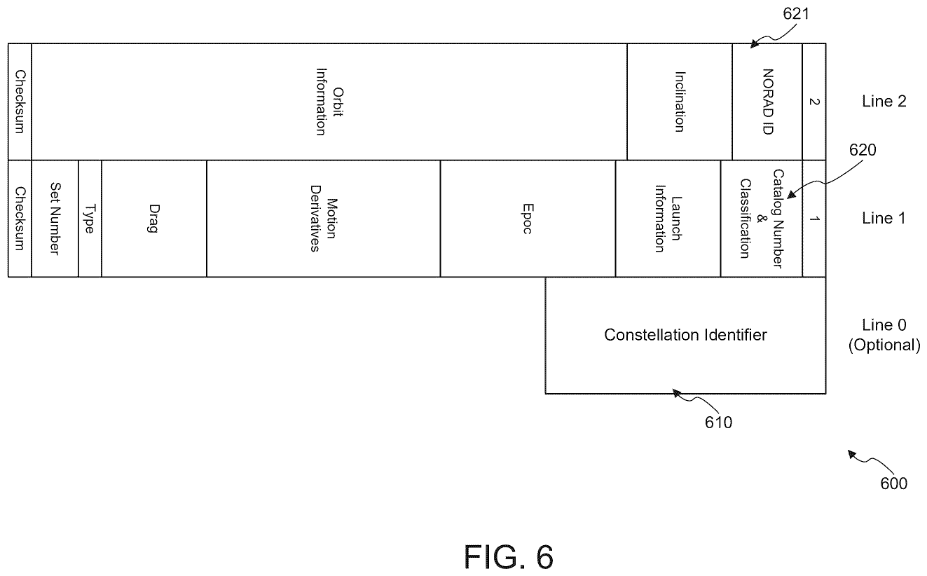

FIG. 2 shows an example method for generating a service area information record corresponding to a service area (e.g., service area 110) associated with a satellite communication system 100. The example method may be performed at the management entity (e.g., management entity 160) of the satellite communication system 100. The management entity may be configured to either receive (e.g., from a service orchestrator external to the communication system 100) and/or generate (e.g., at the management entity 160) at least one information record 210 corresponding to a service area 110 associated with the satellite communication system 100. The at least one information record 210 may be included in a HOP. The at least one information record 210 may include a service area identifier 211 corresponding to the service area 110, and a satellite pass record 215. The satellite pass record 215 may comprise an identifier 212 (e.g., a NORAD identifier) associated with a satellite, for example, satellite 120, a service start timestamp 213 that may correspond to a time at which the satellite 120 may start servicing the service area 110, and a service stop timestamp 214 that may correspond to a time at which the satellite 120 may stop servicing the service area 110. The management entity may be further configured to receive ephemeris data 220 for at least one satellite, including the satellite 120 associated with the at least one information record 210. The ephemeris data 220 for the at least one satellite may comprise a three-line-element (3LE) record, for example, in accordance with 3LE 600 as described herein in FIG. 6. 3LE 600 may comprise, in addition to the mandatory first line (Line 1) and second line (Line 2), also a title line (Line 0), wherein the title line may include 24 characters. Furthermore, while the first line and the second line may include a satellite catalog number (620 and 621, respectively), the title line may include a constellation identifier 610 (e.g., up to 24 characters long), wherein the constellation identifier 610 may correspond to a constellation of satellites comprising the specified satellite (620, 621).

The management entity may be configured to calculate (230), based on the at least one information record 210 and on ephemeris data 220 corresponding to the satellite 120, and referring to FIG. 1, a start position 130 that may correspond to the service start timestamp 213, and a stop position 140 that may correspond to the service stop timestamp 214. The calculated start position 130 and/or the calculated stop position 140 may comprise a longitude value, a latitude value, and an altitude value. The calculated start position 130 and/or the calculated stop position 140 may comprise earth-centered-earth-fixed (ECEF) coordinates (e.g., an X value, a Y value, and a Z value). The calculating of the satellite positions (130, 140) may comprise calculating the satellite positions in accordance with the 4^{th} Simplified General Perturbations model (SGP4), or in accordance with any other applicable model.

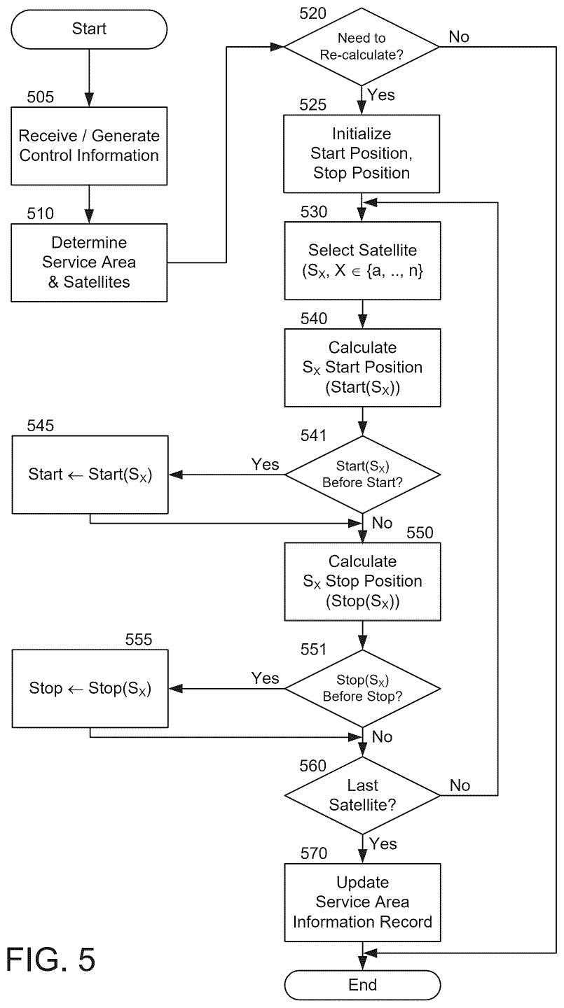

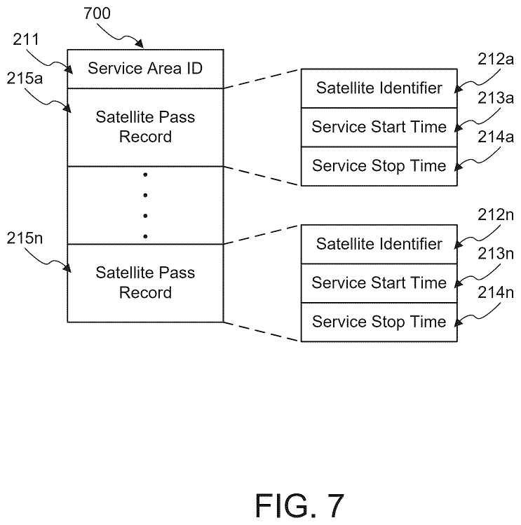

FIG. 5 shows another example method for generating a service area information record corresponding to a service area (e.g., service area 110) associated with a satellite communication system 100. The example method may be performed at the management entity (e.g., management entity 160) of the satellite communication system 100. Specifically, FIG. 5 and FIG. 7, show that the management entity 160 may be configured, in step 505, to either receive (e.g., from a service orchestrator external to the communication system 100) or generate (e.g., at the management entity 160) at least one information record 700 corresponding to a service area 110 associated with the satellite communication system 100. The at least one information record 700 may be included in a HOP. The at least one information record 700 may include a service area identifier 211 corresponding to the service area 110, and multiple satellite pass records 215a-n. A satellite pass record 215 may comprise an identifier 212 (e.g., a NORAD identifier) associated with a satellite, a service start timestamp 213 that may correspond to a time at which the satellite may start servicing the service area 110, and a service stop timestamp 214 that may correspond to a time at which the satellite may stop servicing the service area 110. Each satellite pass record 215 of the multiple satellite pass records 215a-n may correspond to a different satellite, wherein the multiple satellites corresponding to the multiple satellite pass records 215a-n may be associated with a same constellation. The management entity may be further configured to receive, in step 505, ephemeris data (e.g., similar to ephemeris data 220) for at least the multiple satellites corresponding to the information record 700.

In step 510, the management entity may determine a service area and a set of satellites. The management entity may be configured to determine, for example, based on a received at least one information record 700, a service area corresponding to service area identifier 211 (e.g., service area 110), and a set of satellites (e.g., Sₐ to Sₙ) corresponding to the multiple identifiers 212a-n included in the multiple satellite pass records 215a-n.

In step 520, the management entity may determine whether to (re)calculate the start position 130 and/or the stop position 140 corresponding to the service area 110. The management entity may be configured to determine, for example, based on the received at least one information record 700 and/or the ephemeris data, to (re)calculate the start position 130 and/or the stop position 140 corresponding to the service area 110, for example, in response to receiving and/or generating a new HOP (e.g., comprising a new or an updated information record 700) and/or new ephemeris data. A new HOP may be received or generated due to adding service areas to and/or removing service areas from the communication system 100 that may affect a service area coverage scheduling.

In step 525, the management entity may initialize a start position 130 and/or a stop position 140. The management entity may be configured to initialize the start position 130 and/or the stop position 140, for example, to a predefined maximum value in accordance with a predefined order. For example, the satellites of the set of satellites may orbit the Earth from west to east, the predefined maximum value may be associated with a most eastern position, and a position P₁ may be considered to be “before” a position P₂ only if the position P₁ may be to the west of the position P₂.

In step 530, the management entity may be configured to select a satellite from the set of satellites determined in step 510 (e.g., satellite S_{X}, wherein X∈{a, . . . , n}), and, in step 540, calculate a start position (e.g., Start(S_{X})) corresponding to a service start timestamp 213_{X} included in a corresponding satellite pass record 215_{X}. The management entity may be configured to, based on determining, in step 541, that the calculated start position Start(S_{X}) is before the (currently calculated) start position 130, and to set, in step 545, the calculated start position Start(S_{X}) as the (currently calculated) start position 130. In a similar manner, the management entity may be configured to calculate, in step 550, a stop position (e.g., Stop(S_{X})) corresponding to a service stop timestamp 214_{X} included in the corresponding satellite pass record 215_{X}, and based on determining, in step 551, that the calculated stop position Stop(S_{X}) is before the (currently calculated) stop position 140, to set, in step 555, the calculated stop position Stop(S_{X}) as the (currently calculated) stop position 140.

The management entity may be configured to perform steps 530 to 555 for multiple (e.g., all) satellites associated with the set of satellites (e.g., Sₐ to Sₙ), for example, until determining, in step 560, that all the satellites associated with the set of satellites were considered. If positions are ordered from west to east (e.g., as per the example above), then following the determining 560 (e.g., that all satellites of the set of satellites were considered) the start position 130 may be the most west start position calculated for the multiple satellites (e.g., out of Start(Sₐ) to Start(Sₙ)), and the stop position 140 may be the most west stop position calculated for the multiple satellites (e.g., out of Stop(Sₐ) to Stop(Sₙ)). In step 570, the management entity may be configured to, and in response to determining in step 560 that all satellites of the set of satellites were considered, update at least one service area information record 250 in accordance with the calculated start position 130 and/or the calculated stop position 140, as described herein.

Referring to FIG. 2, the management entity may be configured to transmit (e.g., via at least one satellite), a service area information record 250 corresponding to a service area 110, the service area information record 250 may comprise service area information 251 (e.g., a service area identifier, geographic information, service carrier information (e.g., frequency and symbol rate), etc.), a constellation identifier 252, a start position 253 corresponding to the calculated start position 130, and a stop position 254 corresponding to the calculated stop position 140. The start position 253 and/or the stop position 254 may comprise a longitude value, a latitude value, and an altitude value. The start position 253 and/or the stop position 254 may comprise ECEF coordinates (e.g., an X value, a Y value, and a Z value).

If a calculated start position 130 and/or a calculated stop position 140 may be calculated based on an information record 210 corresponding to a single satellite (e.g., satellite 120), the constellation identifier 252 may correspond to the satellite 120 (e.g., based on the 3LE record 220 associated with the satellite 120). If the calculated start position 130 and/or the calculated stop position 140 may be calculated based on an information record 700 corresponding to multiple satellites associated with a same constellation of satellites, the constellation identifier 252 may correspond to any of the multiple satellites (e.g., based on a 3LE record 220 associated with the respective satellite).

The management entity may be configured to transmit (e.g., via at least one satellite) at least one ephemeris data record 260 corresponding to ephemeris data 220, wherein the ephemeris data record 260 may comprise at least a constellation identifier 262 and ephemeris data 261 (e.g., in TLE format). The at least one ephemeris data record 260 may comprise a 3LE record (e.g., in accordance with 3LE 600), and the constellation identifier 262 and the ephemeris data 261 may be included in the 3LE records.

The management entity 160 may be configured to receive and/or generate multiple information records (e.g., 210, 218 or 700) corresponding to multiple service areas associated with a satellite communication system 100. The management entity may be further configured to receive ephemeris data for a plurality of satellites associated with the communication system 100, the plurality of satellites may be further associated with one or more constellations of satellites (e.g., each satellite of the plurality of satellites may be associated with a constellation of satellites of the one or more constellations of satellites). The management entity may be configured to perform the appropriate method of the methods described above for each information record (e.g., 210, 218, or 700). The management entity may be configured to and to transmit (e.g., via one or more satellites of the plurality of satellites) multiple service area information records (250) corresponding to the multiple service areas, and a plurality of ephemeris data records (260) corresponding to the plurality of satellites.

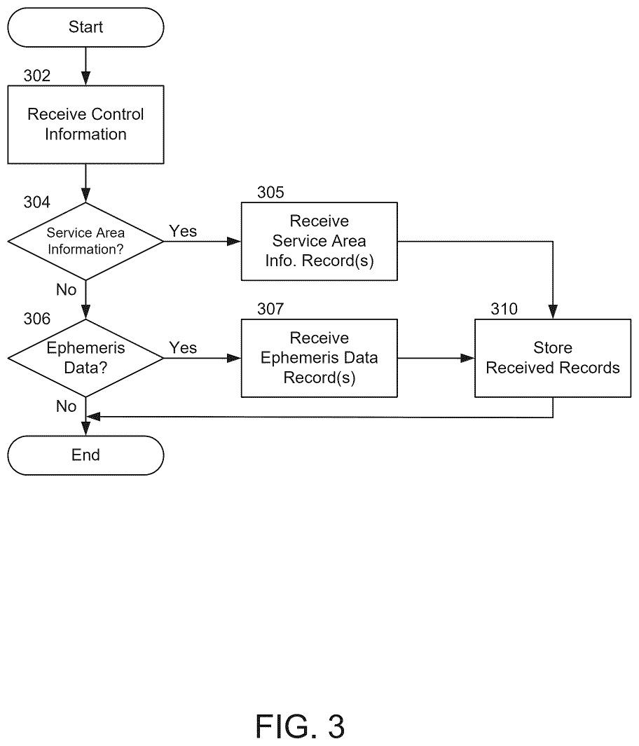

Referring to FIG. 3, a method at a terminal 150 of a communication system 100 may be presented. The method presented may be associated with a modem 151 of terminal 150. The modem 151 may be configured to receive, in step 302, from a management entity associated with the communication system 100 (e.g., management entity 160) control information 161 (e.g., via at least one satellite). In step 304, at a first point in time, if it is determined that service area information may be received, the modem 151 may be configured to receive, in step 305, for example, at least one service area information record 250 corresponding to a service area 110. The service area information record 250 may comprise service area information 251, a constellation identifier 252 corresponding to a constellation of satellites associated with the communication system 100, a start position 253 that may correspond to the calculated start position 130, and a stop position 254 that may correspond to the calculated stop position 140. In step 306, at a second point in time, if it is determined that ephemeris data may be received, the modem 151 may be configured to receive, in step 307, for example, one or more ephemeris data record 260. The ephemeris data record 260 may comprise a constellation identifier 262 corresponding to the constellation of satellites and ephemeris data 261 corresponding to a satellite (e.g., satellite 120) associated with the constellation of satellites. The modem 151 may be configured to, in response to the receiving of the at least one service area information record 250 or to the receiving of the one or more ephemeris data records 260, store, in step 310, the at least one service area information record 250 or the one or more ephemeris data records 260 in a memory associated with the modem 151 (e.g., in non-volatile memory). The first point in time and the second point in time may be at about a same time.

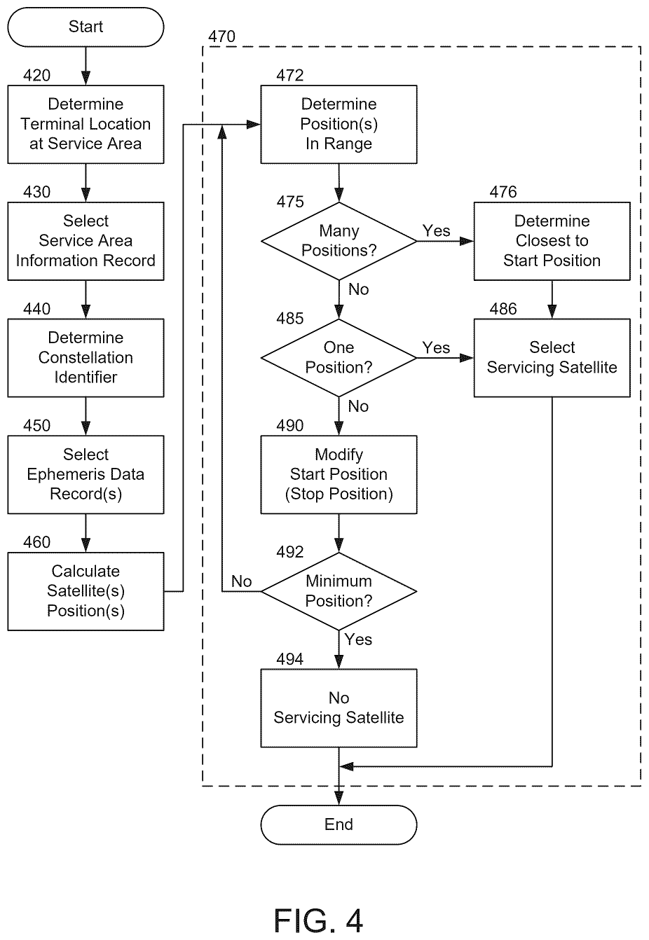

FIG. 4 shows an example method for selecting a service satellite. Specifically, FIG. 4 shows a method that a terminal 150 of communication system 100 may perform to select a service satellite. The modem 151 may be configured to determine, in step 420, for example, if a terminal is about a service area (e.g., service area 110) associated with the communication system 100 at a third point in time that may be different from the first point in time and/or the second point in time. For example, the third point in time may correspond to receiving, at the modem 151, a HOP that may correspond to any movement of satellites associated with the communication system 100, movement of the terminal 150, and/or change of service area information 251 associated with the service area 110. In another example, the third point in time may correspond to a time of powering up or restarting operation of at least the modem 151 (e.g., wherein the modem 151 might not have a valid HOP in memory).

The modem 151 may be configured to, in response to said determining, select, in step 430, from the stored at least one service area information record 250, a service area information record corresponding to the location of the terminal. The selecting may be based on the location of the terminal 150 and on service area information 251 included in the service area information record.

The modem 151 may be configured to determine, in step 440, based on the selected service area information record, a constellation identifier associated with the service area 110. The constellation identifier corresponding to the service area 110 may be determined, for example, in accordance with the constellation identifier 252 included in the selected service area information record.

The modem 151 may be configured to select, in step 450, based on the determined constellation identifier and from the stored one or more ephemeris data records 260, at least one ephemeris data record corresponding to at least one satellite associated with the constellation of satellites corresponding to the constellation identifier. The selecting of the at least one ephemeris data record may be based on a constellation identifier 262 included in the stored at least one ephemeris data record 260. The modem 151 may be configured to calculate in step 460, based on the selected at least one ephemeris data record, a position of the at least one satellite corresponding to the at least one ephemeris data record. The calculated position may correspond to a time of interest (e.g., about the time of the determining that the terminal 150 may be at about the service area 110).

Also, or alternatively, the modem 151 may be configured to select, in step 450, from stored one or more ephemeris data records 260, a plurality of ephemeris data records corresponding to a plurality of satellites associated with the constellation of satellites. The selecting of the plurality of ephemeris data records may be based on a plurality of constellation identifiers 262 included in the stored plurality ephemeris data records 260. The plurality of constellation identifiers may correspond to the constellation of satellites. The modem 151 may be configured to, based on the selected plurality of ephemeris data records, calculate, in step 460, a plurality of positions corresponding to a plurality of satellites. The plurality of satellites may correspond to the plurality of ephemeris data records, and the calculated plurality of positions may correspond to a time of interest (e.g., about the time of the determining that the terminal 150 may be at about the service area 110).

In step 470, the modem may select a servicing satellite. The modem 151 may be configured to select, in step 470, from the at least one satellite (or from the plurality of satellites) associated with the constellation of satellites, a servicing satellite (e.g., satellite 120). The modem 151 may be further configured to command, at about the time of interest, an antenna included in the terminal 150 (e.g., the antenna 152 or the second antenna 153), to search for the selected service satellite 120 at about the calculated position of the satellite 120.

The selecting, in step 470, of a servicing satellite may comprise determining, in step 472, based on the at least one position or on the plurality of positions, one or more positions corresponding to one or more satellites of the constellation of satellites that may possibly service the service area 110 at the time of interest. The determining that a satellite may possibly service the service area may be based on the calculated start position 130 and the calculated stop position 140 associated with the service area 110, and the calculated position of the satellite. Said determining may further comprise comparing the calculated position of the satellite with the start position 253 and the stop position 254 associated with the service area information record corresponding to service area 110, and determining that the satellite's calculated position may be within a volume of space between the start position 253 and the stop position 254.

The modem 151 may be configured to determine in step 475 that more than one position of the calculated positions, calculated in step 460, may be within a volume of space between the start position 253 and the stop position 254. If it is determined in step 475 that more one position of the calculated positions are within the volume of space between the start position 253 and stop position 254, the modem may determine in step 476, from the more than one position, the position closest to the start position 253, and the modem may select in step 486 the servicing satellite in accordance with the position closest to the start position 253 (e.g., select the satellite corresponding to the position closest to the start position 253).

The modem 151 may be configured to determine, in step 485 and based on the determining in step 475, that one position of the calculated positions determined in step 460 may be within a volume of space between the start position 253 and the stop position 254. The modem may select, in step 486, the servicing satellite in accordance with the one position (e.g., select the satellite corresponding to the one position).

The modem 151 may be configured to determine, based on the determining in steps 475 and 485 that none of the calculated positions determined in step 460 may be within a volume of space between the start position 253 and the stop position 254. The modem 151 may be configured to determine, in step 490, in response to said determining, a modified start position that may be before the start position 253 and after a predefined minimum position. The minimum position may correspond to a position associated with a rising of a satellite over the horizon. The satellites associated with the constellation of satellites may orbit the Earth from west to east, and the modified start position may be west to the start position 253 and east to the predefined minimum position. In such embodiments, the determining the modified start position in step 490 may comprise shifting the start position 253 a predefined number of degrees to the west. The determining of a modified start position 253 may comprise determining also a modified stop position 254, wherein the determining a modified stop position 254 may comprise shifting the stop position 254 a predefined number of degrees towards the start position 253 (e.g., to the west).

The modem 151 may be configured to determine in step 492 that at least the modified start position 253 may still be after the minimum position. The modem 151 may be configured to repeat the determining in step 472 of positions corresponding to satellites that may possibly service the service area 110 at the time of interest. This determining may further comprise comparing the calculated positions with the modified start position 253 and the (modified) stop position 254 and determining that one or more calculated positions may be within a volume of space between the modified start position 253 and the (modified) stop position 254.

The modem 151 may be configured to, in response to determining that none of the calculated positions determined in step 460 may be within a volume of space between the start position 253 and the stop position 254, or between a modified start position 253 and (a modified) stop position 254. The modem 151 may be configured to determine in step 492 that the (modified) start position 253 may not be modified any further. The modem 151 may be configured to select in step 494 no servicing satellite for the service area 110.

The volume of space between a start position (e.g., start position 253 or modified start position 253) and a stop position (e.g., stop position 254 or modified stop position 254) may be shaped like a bent cylinder, with the applicable orbit of the constellation being at about the center of the cylinder throughout its length, and with the calculated start position 130 and the calculated stop position 140 being at about the respective centers of the circular edges of the bent cylinder. The diameter of the cylinder may be predefined. The volume of space between the start position and the stop position may be shaped like a bent box, with the applicable orbit of the constellation being at about the center of the box throughout its length, with the calculated start position 130 and the calculated stop position 140 being at about the respective centers of the square edges of the bent box, wherein the dimensions of the square may be predefined. Similarly, the volume of space between the start position and the stop position may be shaped as necessary.

Various aspects of the disclosure may be embodied as one or more methods, systems, apparatuses (e.g., components of a satellite communication network), and/or computer program products. Accordingly, those aspects may take the form of an entirely hardware embodiment, an entirely software embodiment, an entirely firmware embodiment, or an embodiment combining firmware, software, and/or hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. one or more computer readable media storing instructions may be used. The instructions, when executed, may cause one or more apparatuses to perform one or more acts described herein. The one or more computer readable media may comprise transitory and/or non-transitory media. In addition, various signals representing data or events as described herein may be transferred between a source and a destination in the form of electromagnetic waves traveling through signal-conducting media such as metal wires, optical fibers, and/or wireless transmission media (e.g., air and/or space).

Modifications may be made to the various embodiments described herein by those skilled in the art. For example, each of the elements of the aforementioned embodiments may be utilized alone or in combination or sub-combination with elements of the other embodiments. It will also be appreciated and understood that modifications may be made without departing from the true spirit and scope of the present disclosure. The description is thus to be regarded as illustrative instead of restrictive on the present disclosure.

Clause 1. A method comprising:
receiving or generating, at a management entity associated with a satellite communication system, at least one information record, wherein the at least one information record corresponds to a service area associated with the satellite communication system;
receiving, at the management entity, ephemeris data for at least one satellite, wherein the at least one satellite is associated with the at least one information record; and
calculating, at the management entity and based on the at least one information record and on the ephemeris data, a start position and a stop position corresponding to the at least one satellite and to the service area.

Clause 2. The method of clause 1, wherein the at least one information record comprises a service area identifier corresponding to the service area, and a satellite pass record, wherein the satellite pass record comprises an identifier associated with a satellite, a service start timestamp, and a service stop timestamp.

Clause 3. The method of clause 2, wherein the identifier associated with a satellite corresponds to a catalog number associated with the satellite.

Clause 4. The method of clause 3, wherein the catalog number is a NORAD identifier.

Clause 5. The method of clause 2, wherein the service start timestamp corresponds to a time at which the satellite starts servicing the service area, and the service stop timestamp corresponds to a time at which the satellite stops servicing the service area.

Clause 6. The method of clause 1, wherein the ephemeris data includes a satellite catalog number associated with the at least one satellite, and a constellation identifier corresponding to a constellation of satellites comprising the at least one satellite.

Clause 7. The method of clause 6, wherein the ephemeris data is a three-line-element (3LE) record, and wherein the constellation identifier is included in a title line of the record.

Clause 8. The method of clause 2, wherein the start position corresponds to the service start timestamp and the stop position corresponds to the service stop timestamp.

Clause 9. The method of clause 2, wherein the calculating the start position or the stop position comprises calculating the start position or the stop position in accordance with a 4th Simplified General Perturbations model (SGP4).

Clause 10. A method comprising:
receiving or generating, at a management entity associated with a satellite communication system, at least one information record, wherein the at least one information record corresponds to a service area associated with the satellite communication system;
receiving, at the management entity, ephemeris data for multiple satellites;
determining, at the management entity and from the multiple satellites, a subset of satellites corresponding to the information record, wherein all the satellites included in the subset of satellites are associated with a same constellation; and
calculating, at the management entity and based on the at least one information record and at least part of the ephemeris data corresponding to the subset of satellites, a start position and a stop position corresponding to the service area.

Clause 11. The method of clause 10, wherein the at least one information record comprises a service area identifier corresponding to the service area, and one or more satellite pass records corresponding to the subset of satellites.

Clause 12. The method of clause 11, wherein different satellite pass records of the one or more satellite pass records are associated with different satellites of the subset of satellites.

Clause 13. The method of clause 11, wherein each satellite pass record comprises an identifier associated with a satellite, a service start timestamp, and a service stop timestamp.

Clause 14. The method of clause 13, wherein an identifier associated with a satellite corresponds to a catalog number associated with the satellite.

Clause 15. The method of clause 13, wherein a service start timestamp corresponds to a time at which a corresponding satellite starts servicing the service area, and a service stop timestamp corresponds to a time at which the corresponding satellite stops servicing the service area.

### Clause 16. the Method of Clause 10, Further Comprising:

determining, at the management entity, that the start position or the stop position should be modified; and
recalculating the start position or the stop position.

Clause 17. The method of clause 16, wherein the determining that the start position or stop position should be modified is responsive to receiving or generating an updated at least one information record corresponding to the service area, or to receiving new ephemeris data corresponding to any satellite of the subset of satellites.

Clause 18. The method of clause 10, wherein the calculating comprises:
initializing, in accordance with a predefined order, the start position or the stop position to predefined maximum values;
selecting, from the subset of satellites, a satellite;
calculating a start position corresponding to a service start timestamp associated with the selected satellite and included in the at least one information record;
determining that the calculated start position associated with the selected satellite is preceding the start position;
in response to the determining, setting the calculated start position associated with the selected satellite as the start position;
calculating a stop position corresponding to a service stop timestamp associated with the selected satellite and included in the at least one information record; and
determining that the calculated stop position associated with the selected satellite is preceding the stop position; and
in response to the determining, setting the calculated stop position associated with the selected satellite as the stop position.

Clause 19. The method of clause 18, wherein according to the predefined order a first position is preceding a second position if the first position is west of the second position.

Clause 20. The method of clause 18, further comprising:
selecting another satellite from the subset of satellites;
calculating a start position and a stop position corresponding to a service start timestamp and a service stop timestamp associated with the selected another satellite, respectively; and
updating the start position and the stop position in accordance with the predefined order and with the calculated start position and the calculated stop position, respectively.

Clause 21. The method of clause 20, further comprising:
determining that all satellites associated with the subset of satellites were selected;
updating at least one service area information record corresponding to the service area in accordance with the start position and the stop position; and
transmitting, by the management entity and via at least one satellite, the updated service area information record.

Clause 22. The method of clause 21, wherein the service area information record includes at least a service area identifier corresponding to the service area, a constellation identifier corresponding to a constellation associated with the subset of satellites, a start position figure corresponding to the start position, and a stop position figure corresponding to the stop position.

Clause 23. A method comprising:
receiving or generating, at a management entity associated with a satellite communication system, multiple information records that correspond to multiple service areas associated with the satellite communication system;
receiving, at the management entity, ephemeris data for a plurality of satellites, wherein the plurality of satellites are associated with one or more constellations of satellites;
determining, at the management entity, from the plurality of satellites, one or more subsets of satellites corresponding to the multiple information records, wherein all the satellites included in any subset of satellites are associated with a same constellation;
calculating, at the management entity, for at least one service area of the multiple service areas and based on at least one information record corresponding to the at least one service area and at least part of the ephemeris data corresponding to at least one subset of satellites of the one or more subsets of satellites, at least one start position and at least one stop position corresponding to the at least one service area, respectively;
updating at least one service area information record corresponding to the at least one service area in accordance with the corresponding at least one start position and at least one stop position; and
transmitting, by the management entity and via at least one satellite, the updated at least one service area information record.

Clause 24. A method comprising:
receiving, at a terminal of a satellite communication system, via at least one satellite and at a first point in time, a service area information record corresponding to a service area of the satellite communication system;
receiving, at the terminal, via at least one satellite and at a second point in time, one or more ephemeris data records;
storing, at the terminal, the service area information record and the one or more ephemeris data records in a memory associated with the terminal;
determining, at the terminal, at a third point in time, that the terminal is at about the service area;
selecting, at the terminal and responsive to the determining, from one or more service area information records stored in the memory associated with the terminal, the service area information record corresponding to the service area;
determining, at the terminal, a constellation identifier associated with the service area in accordance with the constellation identifier included in the selected service area information record;
selecting, at the terminal, from the stored one or more ephemeris data records, based on the determined constellation identifier, one or more ephemeris data records corresponding to one or more satellites, wherein the one or more satellites are all associated with a constellation of satellites corresponding to the determined constellation identifier;
calculating, at the terminal, based on the selected one or more ephemeris data records, one or more positions of the one or more satellite, respectively, wherein the calculated one or more positions correspond to a time of interest; and selecting, at the terminal, from the one or more satellites, a servicing satellite.

Clause 25. The method of clause 24, wherein the third point in time is after the first point in time and the second point in time.

Clause 26. The method of clause 24, wherein the receiving at the terminal comprises receiving at a modem included in the terminal, and wherein the storing comprises storing the service area information record and the one or more ephemeris data records in non-volatile memory associated with the modem.

Clause 27. The method of clause 24, wherein the receiving at the terminal comprises receiving from a management entity associated with the satellite communication system.

Clause 28. The method of clause 24, wherein the service area information record comprises a service area identifier, a satellite constellation identifier, a start position figure and a stop position figure.

Clause 29. The method of clause 24, wherein any ephemeris data record of the one or more ephemeris data records includes a constellation identifier and a satellite identifier, wherein the satellite corresponding to the satellite identifier is associated with the constellation of satellites corresponding to the constellation identifier.

Clause 30. The method of clause 29, wherein each ephemeris data record is a three-line-element (3LE) record, and wherein the constellation identifier is included in a title line of the 3LE record.

Clause 31. The method of clause 24, wherein the third point in time corresponds to a time of receiving a handover plan, wherein the handover plan corresponds to any of movement of satellites associated with the satellite communication system and movement of the terminal.

Clause 32. The method of clause 24, wherein the third point in time corresponds to a time of receiving a modified service area information record.

Clause 33. The method of clause 24, wherein the third point in time corresponds to a time of powering up or restarting operation of the terminal or of a modem included in the terminal.

Clause 34. The method of clause 24, wherein the selecting the service area information record comprises selecting based on a location of the terminal and on service area information included in the service area information record.

Clause 35. The method of clause 24, wherein the time of interest corresponds to the time of the determining that the terminal is at about the service area.

Clause 36. The method of clause 24, further comprising commanding, at the terminal and at the time of interest, an antenna included in the terminal to search for the selected servicing satellite.

Clause 37. The method of clause 28, wherein the selecting of the servicing satellite comprise:
determining, based on the calculated one or more positions, which of the one or more satellites could service the service area;
selecting, responsive to determining that more than one satellite of the one or more satellites could service the service area, from the more than one satellite, the satellite corresponding to a position closest to the start position figure to be the servicing satellite; and
selecting, responsive to determining that exactly one satellite of the one or more satellites could service the service area, the one satellite to be the servicing satellite.

Clause 38. The method of clause 37, wherein determining that a satellite could service the service area comprises:
comparing a satellite position corresponding to the satellite at the time of interest with the start position figure and the stop position figure included in the service area information record; and
determining that the satellite position is within a volume of space between a start position and a stop position associated with the start position figure and the stop position figure, respectively.

Clause 39. The method of clause 37, further comprising:
determining that none of the one or more satellites could service the service area, wherein the determining comprises determining that none of the calculated one or more positions corresponding to the one or more satellites is within a volume of space between a start position and a stop position associated with the start position figure and the stop position figure;
determining, responsive to the determining that none of the one or more satellites could service the service area, a modified start position, wherein the modified start position is “before” the start position;
determining that the modified start position is exceeding a predefined minimum position; and
repeating at least the determining of which of the one or more satellites could service the service area at the time of interest.

Clause 40. The method of clause 39, wherein the predefined minimum position corresponds to a position associated with a rising of a satellite over a horizon at about the service area.

Clause 41. The method of clause 39, wherein the modified start position is west to the start position and east to the predefined minimum position.

Clause 42. The method of clause 41, wherein the determining the modified start position comprises shifting the start position a predefined number of degrees to the west.

Clause 43. The method of clause 39, further comprising determining a modified stop position by shifting the stop position a predefined number of degrees towards the start position.

Clause 44. The method of clause 43, further comprising:
determining, responsive to determining that none of the calculated one or more positions is within a volume of space between the start position and the stop position, nor within a volume of space between the modified start position and the stop position or the modified stop position, that the start position or the modified start position cannot be further modified; and
selecting, responsive to the determining, no servicing satellite for the service area.

Clause 45. The method of clause 38, wherein:
the volume of space between a start position and a stop position has a shape of a bent cylinder;
an applicable orbit of the constellation being at about the center of the bent cylinder throughout its length;
the start position figure and the stop position figure are at about respective centers of circular edges of the bent cylinder; and
a diameter of the bent cylinder is predefined.

Clause 46. The method of clause 38, wherein:
the volume of space between a start position and a stop position has a shape of a bent box;
an applicable orbit of the constellation being at about the center of the bent box throughout its length;
the start position and the stop position are at about respective centers of square edges of a square of the bent box; and
dimensions of the square may be predefined.

What is claimed is:

1. A method comprising:
receiving or generating, at a management entity associated with a satellite communication system, at least one information record, wherein the at least one information record corresponds to a service area associated with the satellite communication system;
receiving, at the management entity, ephemeris data for at least one satellite, wherein the at least one satellite is associated with the at least one information record; and
calculating, at the management entity and based on the at least one information record and on the ephemeris data, a start position and a stop position corresponding to the at least one satellite and to the service area.

2. The method of claim 1, wherein the at least one information record comprises a service area identifier corresponding to the service area, and a satellite pass record, wherein the satellite pass record comprises an identifier associated with a satellite, a service start timestamp, and a service stop timestamp.

3. The method of claim 2, wherein the service start timestamp corresponds to a time at which the satellite starts servicing the service area, and the service stop timestamp corresponds to a time at which the satellite stops servicing the service area.

4. The method of claim 2, wherein the start position corresponds to the service start timestamp and the stop position corresponds to the service stop timestamp.

5. The method of claim 2, wherein the calculating the start position or the stop position comprises calculating the start position or the stop position in accordance with a 4th Simplified General Perturbations model (SGP4).

6. The method of claim 1, wherein the ephemeris data includes a satellite catalog number associated with the at least one satellite, and a constellation identifier corresponding to a constellation of satellites comprising the at least one satellite.

7. The method of claim 6, wherein the ephemeris data is a three-line-element (3LE) record, and wherein the constellation identifier is included in a title line of the record.

8. A method comprising:
receiving or generating, at a management entity associated with a satellite communication system, at least one information record, wherein the at least one information record corresponds to a service area associated with the satellite communication system;
receiving, at the management entity, ephemeris data for multiple satellites;
determining, at the management entity and from the multiple satellites, a subset of satellites corresponding to the information record, wherein all the satellites included in the subset of satellites are associated with a same constellation; and
calculating, at the management entity and based on the at least one information record and at least part of the ephemeris data corresponding to the subset of satellites, a start position and a stop position corresponding to the service area.

9. The method of claim 8, wherein the at least one information record comprises a service area identifier corresponding to the service area, and one or more satellite pass records corresponding to the subset of satellites.

10. The method of claim 9, wherein each satellite pass record comprises an identifier associated with a satellite, a service start timestamp, and a service stop timestamp.

11. The method of claim 10, wherein a service start timestamp corresponds to a time at which a corresponding satellite starts servicing the service area, and a service stop timestamp corresponds to a time at which the corresponding satellite stops servicing the service area.

12. The method of claim 8, further comprising:
determining, at the management entity, that the start position or the stop position should be modified; and
recalculating the start position or the stop position.

13. The method of claim 8, wherein the calculating comprises:
initializing, in accordance with a predefined order, the start position or the stop position to predefined maximum values;
selecting, from the subset of satellites, a satellite;
calculating a start position corresponding to a service start timestamp associated with the selected satellite and included in the at least one information record;
determining that the calculated start position associated with the selected satellite is preceding the start position;
in response to the determining, setting the calculated start position associated with the selected satellite as the start position;
calculating a stop position corresponding to a service stop timestamp associated with the selected satellite and included in the at least one information record; and
determining that the calculated stop position associated with the selected satellite is preceding the stop position; and
in response to the determining, setting the calculated stop position associated with the selected satellite as the stop position.

14. The method of claim 13, further comprising:
determining that all satellites associated with the subset of satellites were selected;
updating at least one service area information record corresponding to the service area in accordance with the start position and the stop position; and
transmitting, by the management entity and via at least one satellite, the updated service area information record.

15. A method comprising:
receiving, at a terminal of a satellite communication system, via a first satellite and at a first point in time, a service area information record corresponding to a service area of the satellite communication system;
receiving, at the terminal, via a second satellite and at a second point in time, one or more ephemeris data records;
storing, at the terminal, the service area information record and the one or more ephemeris data records in a memory associated with the terminal;
determining, at the terminal, at a third point in time, that the terminal is at about the service area;
selecting, at the terminal and responsive to the determining, from one or more service area information records stored in the memory associated with the terminal, the service area information record corresponding to the service area;
determining, at the terminal, a constellation identifier associated with the service area in accordance with the constellation identifier included in the selected service area information record;
selecting, at the terminal, from the stored one or more ephemeris data records, based on the determined constellation identifier, one or more ephemeris data records corresponding to one or more satellites, wherein the one or more satellites are all associated with a constellation of satellites corresponding to the determined constellation identifier;
calculating, at the terminal, based on the selected one or more ephemeris data records, one or more positions of the one or more satellite, respectively, wherein the calculated one or more positions correspond to a time of interest; and
selecting, at the terminal, from the one or more satellites, a servicing satellite.

16. The method of claim 15, wherein the service area information record comprises a service area identifier, a satellite constellation identifier, a start position figure and a stop position figure.

17. The method of claim 15, wherein any ephemeris data record of the one or more ephemeris data records includes a constellation identifier and a satellite identifier, wherein the satellite corresponding to the satellite identifier is associated with the constellation of satellites corresponding to the constellation identifier; and
wherein each ephemeris data record is a three-line-element (3LE) record, and wherein the constellation identifier is included in a title line of the 3LE record.

18. The method of claim 15, wherein the selecting the service area information record comprises selecting based on a location of the terminal and on service area information included in the service area information record.

19. The method of claim 15, further comprising commanding, at the terminal and at about the time of interest, an antenna included in the terminal to search for the selected servicing satellite.

20. The method of claim 16, wherein the selecting of the servicing satellite comprises:
determining, based on the calculated one or more positions, which of the one or more satellites could service the service area;
selecting, responsive to determining that more than one satellite of the one or more satellites could service the service area, from the more than one satellite, the satellite corresponding to a position closest to the start position figure to be the servicing satellite; and
selecting, responsive to determining that exactly one satellite of the one or more satellites could service the service area, the one satellite to be the servicing satellite.

21. The method of claim 16, wherein determining that a satellite could service the service area comprises:
comparing a satellite position corresponding to the satellite at the time of interest with the start position figure and the stop position figure included in the service area information record; and
determining that the satellite position is within a volume of space between a start position and a stop position associated with the start position figure and the stop position figure, respectively.

22. The method of claim 16, further comprising:
determining that none of the one or more satellites could service the service area, wherein the determining comprises determining that none of the calculated one or more positions corresponding to the one or more satellites is within a volume of space between a start position and a stop position associated with the start position figure and the stop position figure;
determining, responsive to the determining that none of the one or more satellites could service the service area, a modified start position, wherein the modified start position is “before” the start position;
determining that the modified start position is exceeding a predefined minimum position; and
repeating at least the determining of which of the one or more satellites could service the service area at the time of interest.

23. The method of claim 22, wherein the predefined minimum position corresponds to a position associated with a rising of a satellite over a horizon at about the service area;
wherein the modified start position is west to the start position and east to the predefined minimum position;
wherein the determining the modified start position comprises shifting the start position a predefined number of degrees to the west; and
wherein the determining a modified stop position comprises shifting the stop position a predefined number of degrees towards the start position.

24. The method of claim 22, further comprising:
determining, responsive to determining that none of the calculated one or more positions is within a volume of space between the start position and the stop position, nor within a volume of space between the modified start position and the stop position or a modified stop position, that the start position or the modified start position cannot be further modified; and
selecting, responsive to the determining, no servicing satellite for the service area.
